(19) United States
(12) Patent Application Publication
(10) Pub. No.: US 2008/0165936 A1
(43) Pub. Date: Jul. 10, 2008

(54) Information processing apparatus and informatin processing method

(75) Inventors: Youichi Nagashima, Tokyo (JP); Yoshiaki Otaki, Tokyo (JP); Mikio Tsukamoto, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/900,569

(22) Filed: Sep. 12, 2007

(30) Foreign Application Priority Data
Jan. 10, 2007 (JP) P2007-002834

(51) Int. Cl. H04M 11/04

(52) U.S. Cl. 379/51

(57) ABSTRACT

According to an embodiment of the invention, there is provided an information processing apparatus including: an emission unit configured to emit a notification sound upon predetermined operation; a storage unit configured to store a call destination list including a plurality of call destinations; a determination unit configured to determine a call destination based on a preset priority from the plurality of call destinations if the predetermined operation is performed; and a call origination unit configured to originate a call to the determined call destination.

### CROSS-REFERENCE TO RELATED APPLICATIONS

This application is based on and claims the benefit of priority from the prior Japanese Patent Application No. 2007-002834, filed on Jan. 10, 2007; the entire contents of which are incorporated herein by reference.

### TECHNICAL FIELD

The present invention relates to an information processing apparatus and an information processing method, in particular to an information processing apparatus and an information processing method having a crime prevention feature.

### BACKGROUND

In recent years, there have been an increasing number of crimes such as abduction and kidnapping.

It is disclosed by, for example JP-A-2003-24998.1, that cell phones have been proposed having various types of crime prevention features mounted thereon inkling cell phones for children in order to prematurely prevent children from these crimes.

According to the technique disclosed in JP-A-2003-249981, it is possible to automatically record voice and position associated with each other in a successive fashion without manipulating a recording button to identify voice and transmit information on such voice to storage on a remote site based on the user's instruction.

Another technique is proposed where the user manipulates a specific operation key or switch to emit a crime prevention notification sound (that is, a crime prevention buzzer) or illuminate an LED (Light Emitting Diode) as well as transmit a mail to a preset predetermined destination or originate a call to a preset predetermined call destination upon contingency or emergency.

Although, in the above-described related art, a crime prevention notification sound (that is, a crime prevention buzzer) can be emitted or an LED can be illuminated and a mail can be transmitted to a preset predetermined call destination, a mail can be transmitted only once to a destination. A crime prevention feature of the cell phone may be easily broken.

### SUMMARY

According to an aspect of the invention, there is provided an information processing apparatus including: an emission unit configured to emit a notification sound upon predetermined operation; a storage unit configured to store a call destination list including a plurality of call destinations; a determination unit configured to determine a call destination based on a preset priority from the plurality of call destinations if the predetermined operation is performed; and a call origination unit configured to originate a call to the determined call destination.

According to another aspect of the invention, there is provided an information processing apparatus including: an emission unit configured to emit a notification sound upon predetermined operation; a preparation unit configured to prepare a mail text information of a transmit mail which is previously stored; a transmission unit configured to transmit the mail to a preset destination; a determination unit configured to determine whether the emission unit stops to emit the notification sound; and a control unit configured to cause the transmission unit to control to repeat, every preset predetermined transmit interval, a transmission of the mail if it is determined by the determination unit that the emission unit stops to emit the notification sound.

According to another aspect of the invention, there is provided an information processing apparatus including: an emission unit configured to emit a notification sound upon predetermined operation; an acquisition unit configured to acquire information concerning a position of the information processing apparatus; a preparation unit configured to preparing a mail based on the information; a transmission unit configured to transmit the mail; a determination unit configured to determine whether an condition to end a transmission of the mail is satisfied; and a control unit configured to cause the transmission unit to control to repeat, every preset predetermined transmit interval, the transmission of the mail if it is determined by the determination unit that the condition is not satisfied.

According to another aspect of the invention, there is provided an information processing apparatus including: an emission unit configured to emit a notification sound; an acquisition unit configured to acquire information concerning a position of the information processing apparatus; a call origination unit configured to originate a call to another information processing apparatus based on the information acquired by the acquisition unit; a determination unit configured to determine whether a condition to end the call is satisfied; and a control unit configured to cause the call origination unit to control to repeat, every preset predetermined originating interval, the call if it is determined by the determination unit that the condition is not satisfied.

According to another aspect of the invention, there is provided an information processing method including: emitting a notification sound upon predetermined operation; determining a call destination based on a preset priority from a plurality of call destinations included in a call destination list if the predetermined operation is performed; and originating a call to the determined call destination.

### BRIEF DESCRIPTION OF THE DRAWINGS

In the accompanying drawings:

FIGS. 1A, 1B exemplary show an external configuration of a cell phone according to an embodiment of the invention;

FIGS. 2A, 2B exemplary show another external configuration of a cell phone according to the embodiment;

FIGS. 3A, 3B exemplary show another external configuration of a cell phone according to the embodiment;

FIG. 4 is an exemplary block diagram showing the internal configuration of a cell phone according to the embodiment;

FIG. 5 is an exemplary block diagram explaining crime prevention processing in the cell phone shown in FIG. 4;

FIG. 6 shows an example of configuration of a call destination list stored in the storage shown in FIG. 4;

FIG. 7 is an exemplary flowchart explaining further crime prevention processing in the cell phone shown in FIG. 4;

FIGS. 8A, 8E and 8C show examples of configuration of a call destination list stored in the storage shown in FIG. 4;

FIG. 9 is an exemplary flowchart explaining transmit message setting processing in the cell phone shown in FIG. 4;

FIG. 10 is an exemplary flowchart explaining further crime prevention processing in the cell phone shown in FIG. 4;

FIG. 11 is an exemplary flowchart explaining transmission interval setting processing in the cell phone shown in FIG. 4; and

FIG. 12 is an exemplary flowchart explaining further crime prevention processing in the cell phone shown in FIG. 4.

### DESCRIPTION OF THE EMBODIMENTS

Embodiments of the invention will be described referring to drawings.

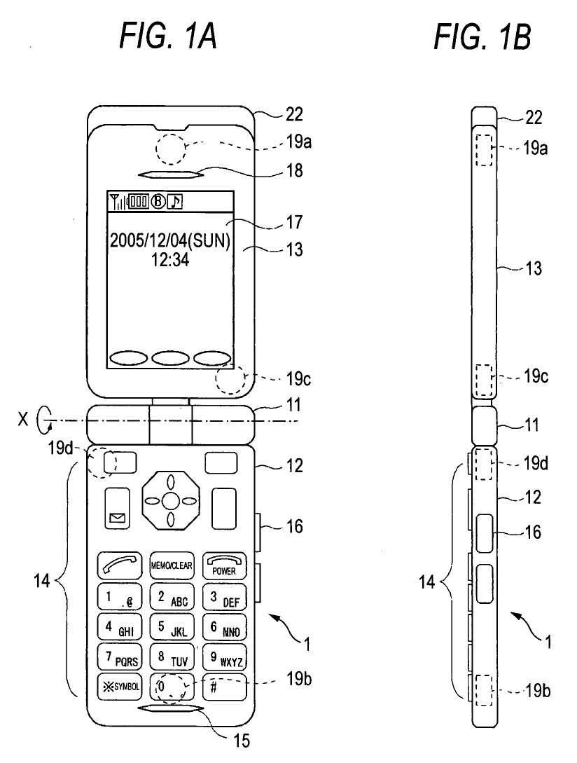

FIG. 1A shows an external configuration of the cell phone 1 unfolded about 180 degrees as viewed from the front. FIG. 1B shows the external configuration of the cell phone 1 unfolded as viewed from the side.

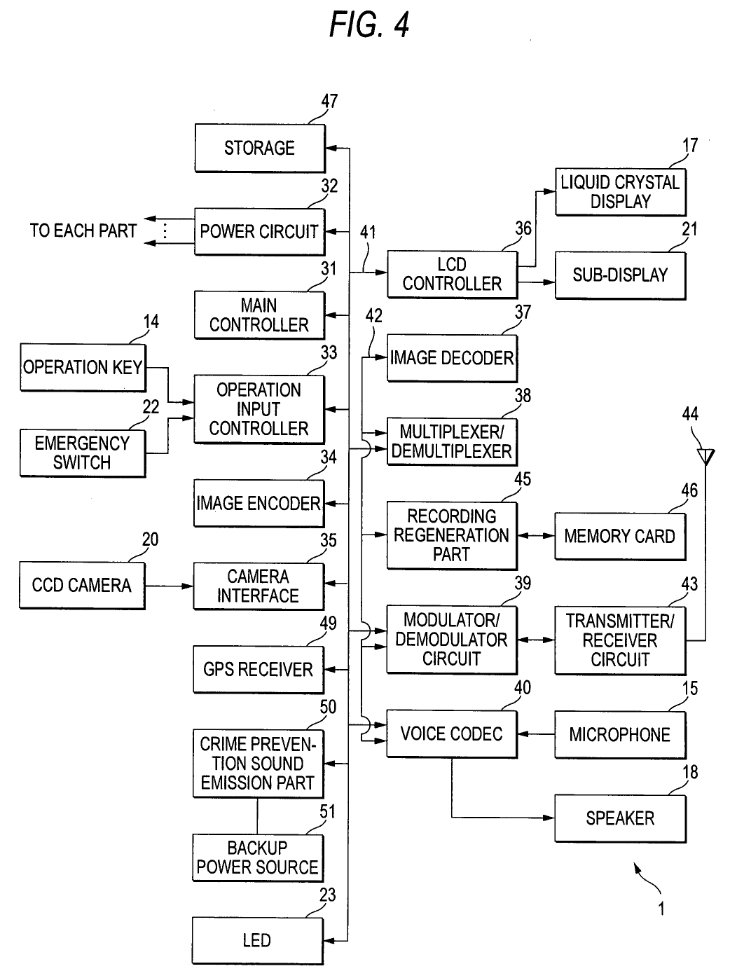

As shown in FIGS. 1A and 1B, the cell phone 1 has a first casing 12 and a second casing 13 hinged by a central hinge part 11, and the cell phone 1 is formed in a foldable fashion in the direction of the arrow X via the hinge part 11. In a predetermined position inside the cell phone 1 is provided an antenna for transmission/reception of radio waves (an antenna 44 in FIG. 4 described later). The cell phone 1 transmits/receives radio waves to/from a base, station (not shown) via the built-in antenna.

On the surface of the first casing 12 are arranged operation keys 14 including numeric keys 0 to 9, an off-hook key, a redial key, an on-hook/power key, a clear key, and an e-mail key. By using the operation keys 14, the user may input various types of instructions.

On the first casing 12 are arranged, in the upper portion, a crosshair key and an enter key as operation keys 14. The user manipulates the crosshair key horizontally or vertically to move a cursor horizontally or vertically. To be more precise, the user scrolls through a directory list or an e-mail list that appears on a liquid crystal display provided on the second casing 13 as well as performs page turning and image advancing on a simple home page and other types of operations.

The user may validate various types of operations by pressing the enter key. For example, on the first casing 12, a desired directory number is selected from among the plurality of directory numbers in the directory list presented in the liquid crystal display 17 in accordance with the user's operation. With the enter key pressed in the inner direction of the first casing 12, the selected directory number is validated and a call is initiated to the directory number.

On the first casing 12, an e-mail key is arranged to the left of the crosshair key and enter key. When the e-mail key is pressed in the inner direction of the first casing 12, the e-mail communication feature is activated. To the right of the crosshair key and enter key, a browser key is provided. When the browser key is pressed in the inner direction of the first casing 12, the data on a web page can be browsed. The e-mail key and the browser key to the left and right of the crosshair key and enter key may have various features such as “Yes” and “No” depending on the screen presented on the liquid crystal display 17, so that the keys are respectively called the soft 1 key and the soft 2 key.

On the first casing 12, a microphone 15 is provided below the operation keys 14. The microphone 15 is used to collect the voice of the user during conversation. On the first casing 12 is provided a side key 16 for operating the cell phone 1.

Into the first casing 12 is inserted on the back a battery pack (not shown). When the on-hook/power key is turned ON, power is fed to circuits from the battery pack to activate the cell phone 1 to place it in the operating state.

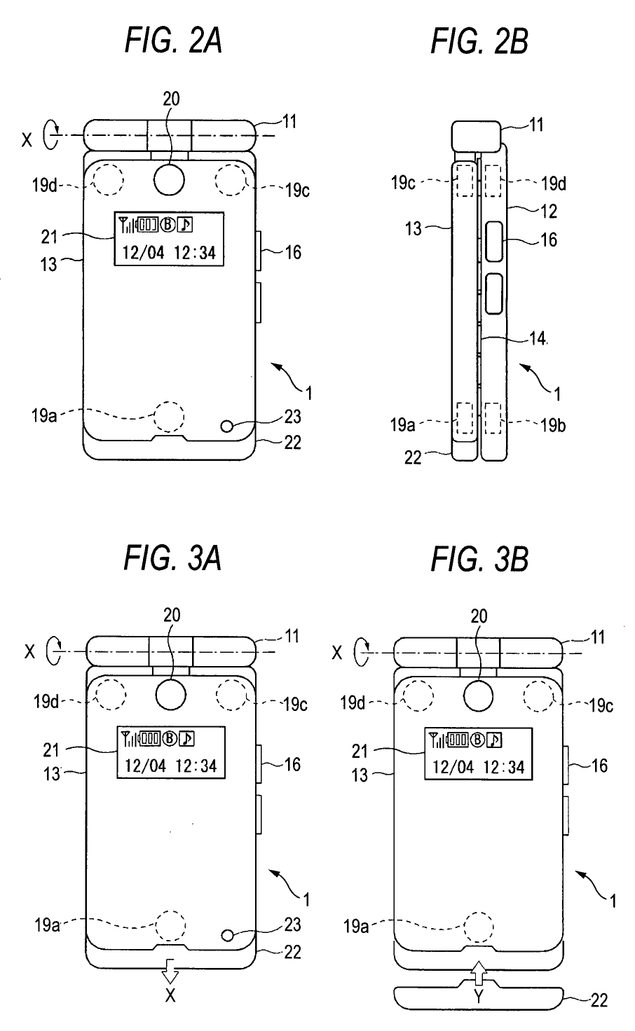

On the second casing 13 is provided a liquid crystal display 17 (main display) in the front. The liquid crystal display 17 serves to display the radio wave receiving state, residual battery power, names of distant parties registered in a directory, corresponding directory numbers and transmission history as well as the content of an e-mail, a simple home page, an image photographed with a CCD (Charge Coupled Device) camera (CCD camera 20 shown in FIG. 2A described later), a content received from an external content server (not shown), and a content stored on a memory card (memory card 46 shown in FIG. 4 described later).

In a predetermined position in the upper area of the liquid crystal display 17 is provided a speaker 18 used by the user for voice calls.

FIG. 2A shows the external configuration of the cell phone 1 folded as viewed from the front. FIG. 2B shows the external configuration of the cell phone 1 folded as viewed from the side.

In the upper area of the second casing 13 is provided a CCD camera 20 which allows the user to photograph a desired object. Below the CCD camera 20 is provided a sub-display 21 that presents an antenna pictograph showing the current antenna sensitivity, a battery pictograph showing the residual battery level of the cell phone 1 and the current time.

Below the sub-display 21 is further provided an LED (Light Emitting Diode) 23 as a crime prevention lamp. The LED 23 illuminates at predetermined intervals with the predetermined operation of the user upon contingency or emergency.

FIGS. 3A, 3B show that the cell phone 1 is in a state where the cell phone 1 shown in FIGS. 1A, 1B is rotated in the direction of an arrow X. The external configuration of the cell phone 1 folded as viewed from the rear.

As shown in FIG. 3A, in a predetermined position of the first casing 12 is provided detachably in vertical direction an emergency switch 22 for causing a crime prevention notification sound emission part (crime prevention notification sound emission part 50 in FIG. 4) to emit a crime prevention notification sound (that is, a crime prevention buzzer) and also blink a crime prevention notification lamp by an LED 23 upon contingency or emergency.

In case, for example, causing the crime prevention notification sound emission part to emit a crime prevention notification sound upon contingency or emergency, the user slides the emergency switch 22 downward in the direction of an arrow X to cause the crime prevention notification sound emission part to emit a crime prevention notification sound upon contingency or emergency. As shown in FIG. 3B, the emergency switch 22 is slid up in the direction an arrow Y by the user to be mounted on the second casing 13 to return to its original position.

Alternatively, a strap-type emergency switch 22 may be used for causing the crime prevention notification sound emission part to emit a crime prevention notification sound by pulling out the strap instead of the detachable emergency switch 22. Or, another sliding-type emergency switch 22 may be used.

FIG. 4 shows the internal configuration of a cell phone 1 serving as an information processing device.

FIG. 4 shows that the cell phone 1 includes a main controller 31 for universally controlling each part of the first casing 12 and the second casing 13. A main bus 41 interconnects, to the main controller 31, a power circuit 32, an operation input controller 33, an image encoder 34, a camera interface 35, an LCD (Liquid Crystal Display) controller 36, a multiplexer/demultiplexer 38, a modulator/demodulator circuit 39, a voice CODEC 40, a storage 47, a music controller 48, a GPS receiver 49, and a crime prevention notification sound emission part 50. A synchronous bus 42 interconnects the image encoder 34, an image decoder 37, the multiplexer/demultiplexer 38, the modulator/demodulator circuit 39, the voice CODEC 40, and a recording regeneration part 45.

The main controller 31 is composed of a CPU (Central Processing Unit), a ROM (Read Only Memory) and a RAM (Random Access Memory). The CPU executes various types of processing in accordance with a variety of applications loaded from a program stored in the RAM or from the storage 47 as well as generates various control signals and transmits the signals to each part thus universally controlling the cell phone 1. The RAM stores data for various types of processing that CPU executes.

The main controller 31 includes a built-in timer for correctly measuring the current date and time.

The cell phone 1 converts a sound signal collected with the microphone 15 in a voice call mode to a digital sound signal and compresses the same by the voice CODEC 40, executes spread spectrum processing on the digital sound signal in the modulator/demodulator circuit 39, converts the digital sound signal to an analog signal, executes frequency conversion on the analog signal in a transmitter/receiver circuit 43, and transmits the resulting analog signal via an antenna 44, based on the control of the main controller 31.

The cell phone 1 amplifies a receive signal received via the antenna 44 in the voice call mode, executes frequency conversion and analog-to-digital conversion on the amplified signal. The cell phone 1 then executes inverse spread spectrum processing on the signal in the modulator/demodulator circuit 39, expands the signal in the voice CODEC 40, converts the signal to an analog sound signal, and outputs the resulting analog sound signal via the speaker 18.

Further, when transmitting an e-mail in the data call mode, the cell phone 1 transmits the text data of an e-mail inputted by the manipulation of the operation key 14 to the main controller 31 via the operation input controller 33. The main controller 31 executes spread spectrum processing on the text data in the modulator/demodulator circuit 39, executes digital-to-analog conversion and frequency conversion on the text data in the transmitter/receiver circuit 43, and transmits the resulting text data to a base station (not shown) via the antenna 44.

When receiving an e-mail in a data call mode, the cell phone executes inverse spread spectrum processing on a receive signal received from a base station (not shown) via the antenna 44 in the modulator/demodulator circuit 39 and restores the original text data, then displays the text data as an e-mail on the liquid crystal display 17 via the LCD controller 36.

After that, the cell phone may record an e-mail received in accordance with the user's operation onto a memory card 46 via the recording regeneration part 45.

When not transmitting an image signal, the cell phone 1 directly displays a signal of an image photographed with the CCD camera 20 on the liquid crystal display 17 via the camera interface 35 and the LCD controller 46.

When transmitting an image signal in the data call mode, the cell phone 1 supplies a signal of an image photographed with the CCD camera 20 to the image encoder 34 via the camera interface 35.

The image encoder 34 compresses and encodes the image signal supplied from the CCD camera 20 by using a predetermined encoding system such as MPEG (Moving Picture Experts Group) 4 to convert the image signal to an encoded image signal, and transmits the resulting encoded image signal to the multiplexer/demultiplexer 38. At the same time, the cell phone 1 transmits, as a digital sound signal, the sound collected with the microphone 15 during photography using the CCD camera 20 to the multiplexer/demultiplexer 38 via the voice CODEC 40.

The multiplexer/demultiplexer 38 multiplexes the encoded image signal supplied from the image encoder 34 and the sound signal supplied from the voice CODEC 40 by using a predetermined system. The multiplexer/demultiplexer 38 then executes spread spectrum processing on the resulting multiplexed signal in the modulator/demodulator circuit 39, executes digital-to-analog conversion and frequency conversion on the multiplexed signal in the transmitter/receiver circuit 43, and transmits the signal via the antenna 44.

The cell phone 1 is capable of receiving data on a web page in the data call mode.

When the cell phone 1 transmits data requesting a web page in the data call mode, the data on the web page is transmitted via a base station (not shown) in response to the request. The data on the web page is received by the transmitter/receiver circuit 43 and the modulator/demodulator circuit 39. The transmitter/receiver circuit 43 and the modulator/demodulator circuit 39 transmit the received data on the web page to the main controller 31.

The main controller 31 interprets the data on the web page and creates a screen (image) that is based on the interpretation. The screen prepared is supplied to the liquid crystal display 17 via the LCD controller 36 from the main controller 31 and displayed thereon. That is, at least an application program of a web browser is installed in the ROM of the main controller 31 or the storage 47. The CPU of the main controller 31 executes an application program of a web browser on the RAM thus acting as a web browser and interprets data on the web page.

When receiving data of a moving picture file linked to; a web page or the like in the data call mode, the cell phone 1 executes inverse spread spectrum processing on a receive signal received from a base station (not shown) via the antenna 44 in the modulator/demodulator circuit 39, and transmits the resulting multiplexed signal to the multiplexer/demultiplexer 38.

The multiplexer/demultiplexer 38 demultiplexes a multiplexed signal to separate the same into an encoded image signal and a sound signal, supplies the encoded image signal to the image decoder 37 via the synchronous bus 42 as well as supplies the sound signal to the voice CODEC 40. The image decoder 37 decodes the encoded image signal by using a decoding system supporting a predetermined encoding system such as MPEG4 to generate a playback moving picture signal, and supplies the playback moving picture signal thus generated to the liquid crystal display 17 via the LCD controller 36. This displays moving picture data included in a moving picture file linked to a web page or the like.

At the same time, the voice CODEC 40 converts the sound signal to an analog sound signal and supplies the same to the speaker 18. This reproduces a sound signal included in a moving picture file linked to a web page or the like. In this case, same as the case of an e-mail, the cell phone 1 is capable of recording, via the recording regeneration part 45, data linked to a web page or the like received onto the memory card 46 by the user's operation.

The storage 47 is composed of for example a flash memory element or an HDD (Hard Disc Drive) as a nonvolatile memory that allows electrical overwriting or erasure and stores various types of application programs executed by the CPU of the main controller 31 and various types of data groups. The storage 47 stores, e-mail data received in accordance with the user's operation and moving picture data included in a moving picture file linked to a received web page or the like.

The GPS receiver 49 receives GPS waves (GPS information such as latitude and longitude information) coming from a GPS broadcast station (not shown). The GPS information includes for example origination time information from respective GPS satellites. In the main controller 31, positional information (latitude and longitude information) indicating the current location of the cell phone 1 is calculated (preferably from three or four pieces of GPS information) to obtain the positional information indicating the current location of the cell phone 1. While a latitude and a longitude are generally acquired as positional information acquired based on the GPS information, address information corresponding to a latitude and a longitude may be acquired. When a latitude and a longitude or address information corresponding to a latitude and a longitude is acquire, such address information may be acquired by accessing an external server (not shown) or the like. Thus, “positional information” includes positional information calculated from GPS information (such as latitude/longitude information) and address information corresponding to the positional information.

The crime prevention notification sound emission part 50 uses the power supplied from a backup power source 51 to emit a crime prevention notification sound (that is, a crime prevention buzzer) upon contingency or emergency in accordance with a control of the main controller 31. The crime prevention notification sound emission part 50 is capable of continuously emitting a crime prevention notification sound and light by a power fed from the backup power source 51 connected to the crime prevention notification sound emission part 50 and the LED 23 even in case a batter pack (not shown) housed in the cell phone 1 is intentionally removed.

Although, in the related art, a crime prevention notification sound (that is, a crime prevention buzzer) can be emitted or an LED can be illuminated and a mail can be transmitted to a preset predetermined call destination, a mail can be transmitted only once to a destination. This presents a problem of an easily breakable crime prevention feature.

In the present embodiment, the crime prevention notification sound emission part 50 is used to emit a crime prevention notification sound (that is, a crime prevention buzzer) or the LED 23 is illuminated upon contingency or emergency. At the same time, a call destination list where call destinations are registered is used to sequentially originate calls to the call destinations. This enhances the crime prevention effect. Crime prevention processing in the cell phone 1 shown in FIG. 4 using this method will be described.

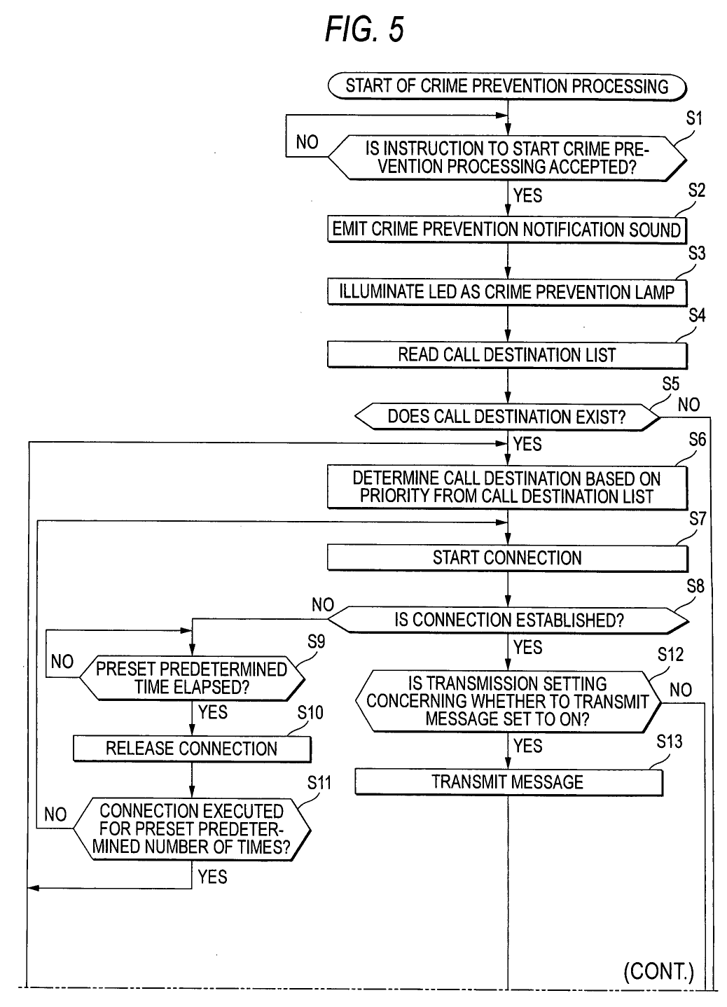

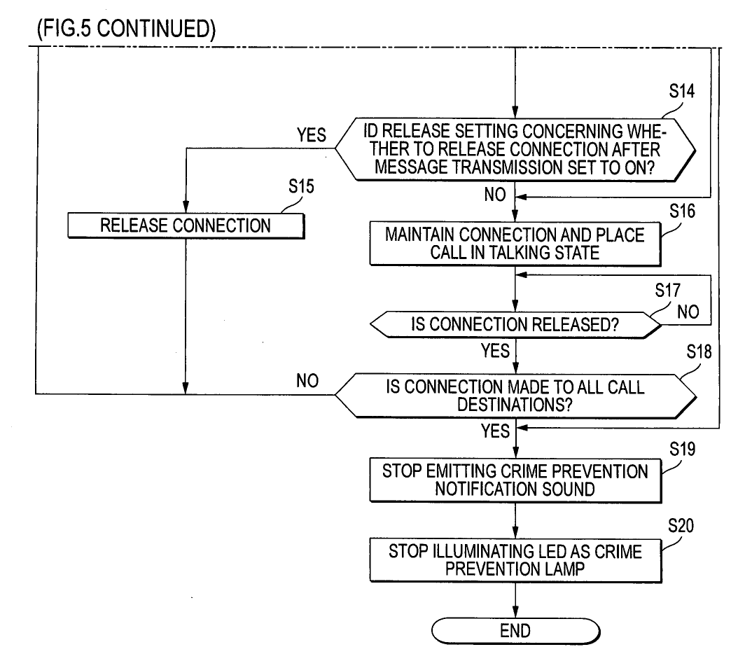

The crime prevention processing in the cell phone 1 shown in FIG. 4 is described below referring to the flowchart of FIG. 5. This crime prevention processing is started when an instruction to start crime prevention processing is accepted for example upon manipulation of an emergency switch 22 or an operation key 14 by the user.

In step S1, the main controller 31 determines whether an instruction to start crime prevention processing is accepted for example upon manipulation of the emergency switch 22 or the operation key 14 by the user. The main controller 31 waits until it is determined that an instruction to start crime prevention processing is accepted for example upon manipulation of the emergency switch 22 or the operation key 14 by the user.

In case it is determined in step S1 that an instruction to start crime prevention processing is accepted for example upon manipulation of the emergency switch 22 or the operation key 14 by the user, the main controller 31 controls the crime prevention notification sound emission part 50 in step S2 to cause it to emit a crime prevention notification sound for contingency or emergency in accordance with the control of the main controller 31. The crime prevention notification sound emission part 50 emits a crime prevention notification sound for contingency or emergency in accordance with the control of the main controller 31.

In step S3, the main controller 31 controls the LED 23 to cause the LED 23 as a crime prevention lamp for contingency or emergency to illuminate at predetermined intervals. The LED 23 as a crime prevention lamp for contingency or emergency illuminates in accordance with the control of the main controller 31.

The sequence of the processing in step S2 and that in step S3 may be altered or processing in step S2 and that in step S3 may be executed simultaneously in parallel.

In step S4, the main controller 31 reads a call destination list where target call destinations to be called upon contingency or emergency are previously registered. The call destination is stored in the storage 47.

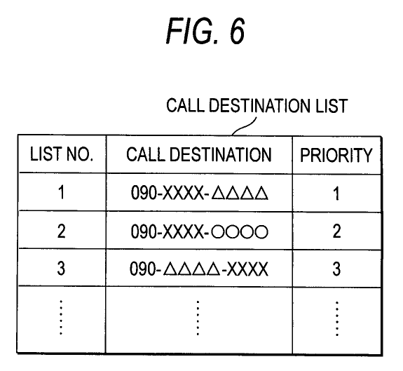

For example, the call destination list shown in FIG. 6 is read. In the example of FIG. 6, the numbers “090-xxxx-ΔΔΔΔ”, “090-xxxx-◯◯◯◯” and “090-ΔΔΔΔ-xxxx” are registered as call destinations. These call destinations have corresponding priorities registered in advance to originate a call upon contingency or emergency. For example, the call destination “090-xxxx-ΔΔΔΔ” has a corresponding priority “1” registered in advance.

The user may add a call destination or update or delete an existing call destination in the call destination list stored in the storage 47 in accordance with the preferences of the user.

In step S5, the main controller 31 references the readout call destination list (call destination list where call destinations to be called upon contingency or emergency are previously registered) and determines whether at least one call destination exists in the call destination list.

Unless at least one call destination to be called upon contingency or emergency exists in the call destination list, it is determined that at least one call destination does not exist in the call destination list.

In case it is determined in step S5 that at least one call destination exists in the call destination list, the main controller 31 determines, in step S6, a call destination to be called upon contingency or emergency based on its priority from the readout call destination list (call destination list where call destinations to be called upon contingency or emergency are previously registered).

In the case of FIG. 6, the call destination of the priority “1” is “090-xxxx-ΔΔΔΔ” so that it is determined that the call destination to be called upon contingency or emergency is “090-xxxx-ΔΔΔΔ”.

In step S7, the main controller 31 starts a connection to the determined call destination (such as another cell phone 1 or a fixed telephone set) via a modulator/demodulator circuit 39, a transmitter/receiver circuit 43, an antenna 44, and a base station (not shown).

In step S8, the main controller 31 determines whether a connection to the determined call destination is established via the modulator/demodulator circuit 39, the transmitter/receiver circuit 43, the antenna 44, and the base station (not shown).

Processing of connection to a determined call destination may result in a case where a response from the call destination is “busy” or “ringing” and the call does not enter a talking state (including a case where the directory number of the call destination is nonexistent). In such a case, it is determined that a connection to the determined call destination is not established.

In case it is determined that a connection to the determined call destination is not established in step S8, the main controller 31 uses a built-in timer to determine whether a preset predetermined time (for example 20 seconds) has elapsed and waits until it is determined that a preset predetermined time (for example 20 seconds) has elapsed in step S9. The preset predetermined time may be set shorter considering the emergency of the situation or set a little longer.

In case it is determined that a preset predetermined time (for example 20 seconds) has elapsed in step S9, the main controller 31 controls the modulator/demodulator circuit 39, the transmitter/receiver circuit 43, and the antenna 44 to release the connection to the determined call destination (Step S10). This temporarily releases the connection to the determined call destination.

In step S11, the main controller 31 determines whether processing of connection is executed to one call destination for a preset predetermined number of times (for example twice or three times). In case it is determined in step 11 that processing of connection is not executed to one call destination for a preset predetermined number of times (for example twice or three times), execution returns to step S7 and the processing is repeated from step S7. That is, processing of connection to the determined call destination is repeated. This executes processing of connection to the determined call destination for a preset predetermined number of times (for example twice or three times).

In case it is determined in step 11 that processing of connection is executed to one call destination for a preset predetermined number of times (for example twice or three times), execution returns to step S6, where a new call destination is determined based on its priority referring to the call destination list from among the call destinations other than the one connected earlier.

In the example of FIG. 6, in case a connection to “090-xxxx-ΔΔΔΔ” as the call destination having a priority “1” is not established, the number “090-xxxx-◯◯◯◯” having a priority “2” is determined as a next call destination.

In case it is determined in step S8 that a connection is established, the main controller 31 determined in step S12 whether the transmission setting concerning whether to transmit a message in call origination upon contingency or emergency is set to ON. The transmission setting is stored on the storage 47.

Whether to transmit a message in call origination upon contingency or emergency may be previously set in accordance with the preferences of the user.

In case it is determined in step S12 that the transmission setting concerning whether to transmit a message in call origination upon contingency or emergency is set to ON, the main controller 31 reads, in Step S13, a transmit message stored in the storage 47, decodes (expands) the read out transmit message using a decoding system supporting a predetermined encoding system in the voice CODEC 40, and transmits the decoded (expanded) digital sound signal via the modulator/demodulator circuit 39, the transmitter/receiver circuit 43, and the antenna 44.

For example, a fixed message such as “Emergency has occurred.” is transmitted to a call destination as a transmit message. A transmit message is not limited to such a fixed message but may be a message recorded in accordance with the preferences of the user (for example, “Help!”). Or, a message may be transmitted including a sound signal obtained by converting positional information that is based on the GPS positioning obtained using the GPS information received by the GPS receiver 49 from a GPS satellite (not shown). This notifies the user's current location easily and accurately. Positional information on a base station (not shown) may be used instead of the positional information that is based on GPS positioning.

In step S14, the main controller 31 determines whether the release setting stored in the storage 47 concerning whether to release a connection after message transmission is set to ON.

Whether to release connection after message transmission may be set in accordance with the preferences of the user.

In case it is determined in step S14 that the release setting stored in the storage 47 concerning whether to release a connection after message transmission is set to ON, the main controller 31 controls in step S15 the modulator/demodulator circuit 39, the transmitter/receiver circuit 43, and the antenna 44 to release a connection to the call destination after message transmission. This temporarily releases processing of connection to the call destination.

Execution then returns to step S6 and the processing is repeated from step S6. That is, in step S6, a new call destination is determined from among the call destinations other than the previously connected call destination.

In case it is determined in step S14 that the release setting stored in the storage 47 concerning whether to release a connection after message transmission is not set to ON, the main controller 31 controls in step S16 the modulator/demodulator circuit 39, the transmitter/receiver circuit 43, and the antenna 44 to maintain connection to the call destination to place the call in a talking state where the user may talk with the distant party at the call destination.

In case it is determined in step S12 that the transmission setting concerning whether to transmit a message is in call origination upon contingency or emergency is not set to ON, processing in steps S13 and S14 is skipped. The transmission setting is stored on the storage 47.

In step S17, the main controller 31 determines, via the modulator/demodulator circuit 39, the transmitter/receiver circuit 43, and the antenna 44, whether the existing connection to the call destination is released or an instruction to the existing connection to the call destination is accepted and the connection is released upon manipulation of the operation key 14 by the user, and waits until it is determined that the connection is released.

In case it is determined in step S17 that the existing connection to the call destination is released, the main controller 31 references the readout call destination list in step S18 to determine whether connection is made to all the call destinations. In case it is determined in step S18 that connection is not made to all the call destinations, execution returns to step S6 and the processing is repeated from step S6. This executes processing of connection to all call destinations previously registered in the call destination list.

In case it is determined in step S18 that connection is made to all the call destinations, the main controller 31 controls the crime prevention notification sound emission part 50 in step S19 to cause it to stop emitting a crime prevention notification sound for contingency or emergency. The crime prevention notification sound emission part 50 stops emitting a crime prevention notification sound for contingency or emergency in accordance with the control of the main controller 31.

While emission of a crime prevention notification sound for contingency or emergency is stopped immediately following connection to all call destinations, the embodiment is not limited thereto. For example, setting is allowed where a crime prevention notification sound for contingency or emergency remains ON until an instruction to terminate the crime prevention processing may be made by the user manipulating the emergency switch 22 or the operation key 14.

In step S20, the main controller 31 controls the LED 23 to cause the LED 23 as a crime prevention lamp for contingency or emergency to stop illuminating in accordance with the control of the main controller 31.

After that, the crime prevention processing is terminated.

In case it is determined in step S5 that no call destinations exist in the call destination list, processing in steps S6 through S18 is skipped. This skips processing of connection to a call destination.

In the crime prevention processing described referring to the flowchart of FIG. 5, it is possible to read a call destination list stored in the storage 47 and determine a call destination based on its priority from the readout call destination list as well as start connection to the determined call destination.

In case a connection to a determined call destination is established, when the transmission setting concerning whether to transmit a message is set to ON, the message is transmitted to the call destination and the connection may be automatically released or maintained in the talking state. When the transmission setting concerning whether to transmit a message is not set to ON, the message is not transmitted to the call destination and the connection may be maintained in the talking state.

Setting of whether to automatically release the connection after a message is transmitted is allowed.

After that, same processing of connection may be made to all call destinations registered to the call destination list.

This allows call origination to a plurality of call destinations previously registered upon contingency or emergency. The user has to issue an instruction to start crime prevention processing only once for example by manipulating an emergency switch 24. As a result, it is possible to enhance the convenience in the crime prevention processing in the cell phone 1. In case one of the registered call destinations is busy or absent and thus cannot answer the call, it is possible to sequentially originate calls to the other plurality of call destinations. This reduces the possibility of failure to notice the situation of contingency or emergency thereby reliably notify the parents or friends or other people of the contingency or emergency happening to the user.

This enhances the crime prevention effect.

In the crime prevention processing described referring to the flowchart of FIG. 5, the mail transmission/reception feature of the cell phone 1 may be used at the same time.

In the crime prevention processing described referring to the flowchart of FIG. 5, connection is not retried to a call destination that is not connected although connection processing has been made for a preset predetermined number of times. Including such a case, a call destination that is not connected may be left behind the remaining call destinations and connection to the call destination may be retried later until a connection is established. Further crime prevention processing using this method in the cell phone 1 shown in FIG. 4 will be described.

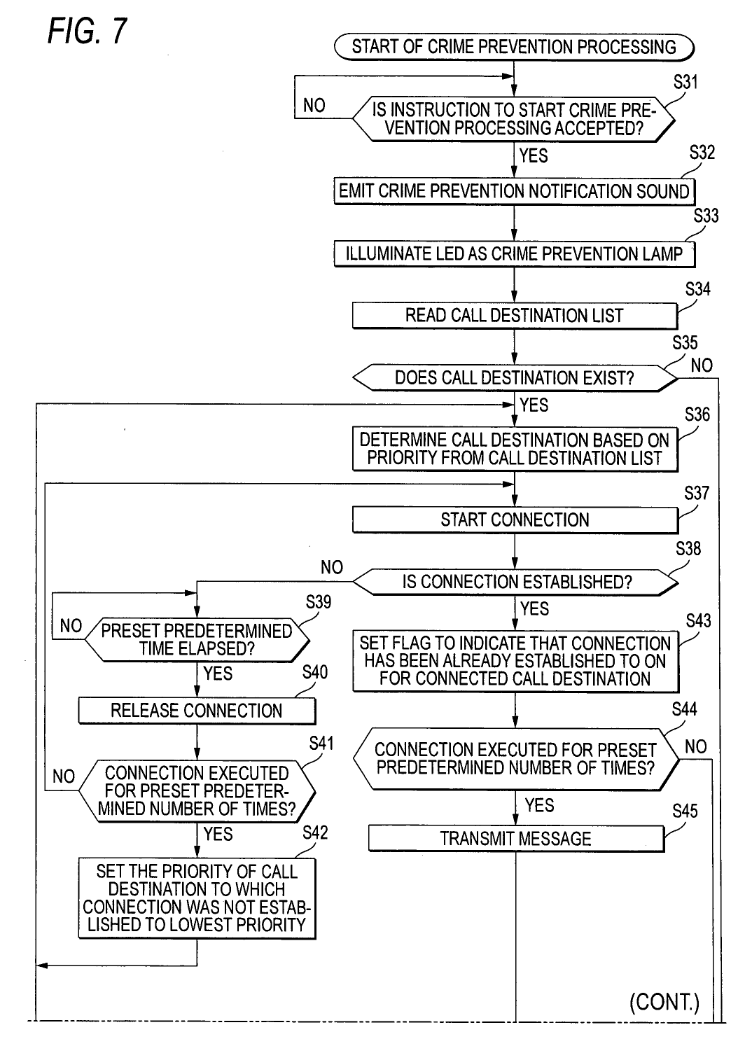

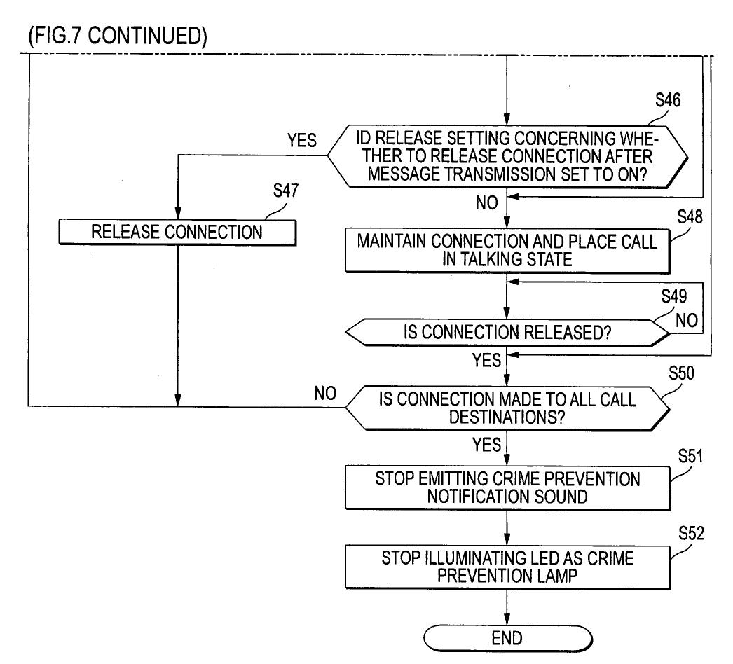

Further crime prevention processing in the cell phone 1 shown in FIG. 4 will be described referring to the flowchart of FIG. 7. Processing in steps S31 trough S41 and processing in steps S44 through S52 is the same as the processing in S1 through S20 in FIG. 5 so that the corresponding description is redundant and thus omitted.

In case it is determined in step S41 that processing of connection to a single call destination is executed for a preset predetermined number of times (for example two or three times), the main controller 31 uses the readout call destination list to set the priority of a call destination to which a connection was not established to the lowest priority in step S42.

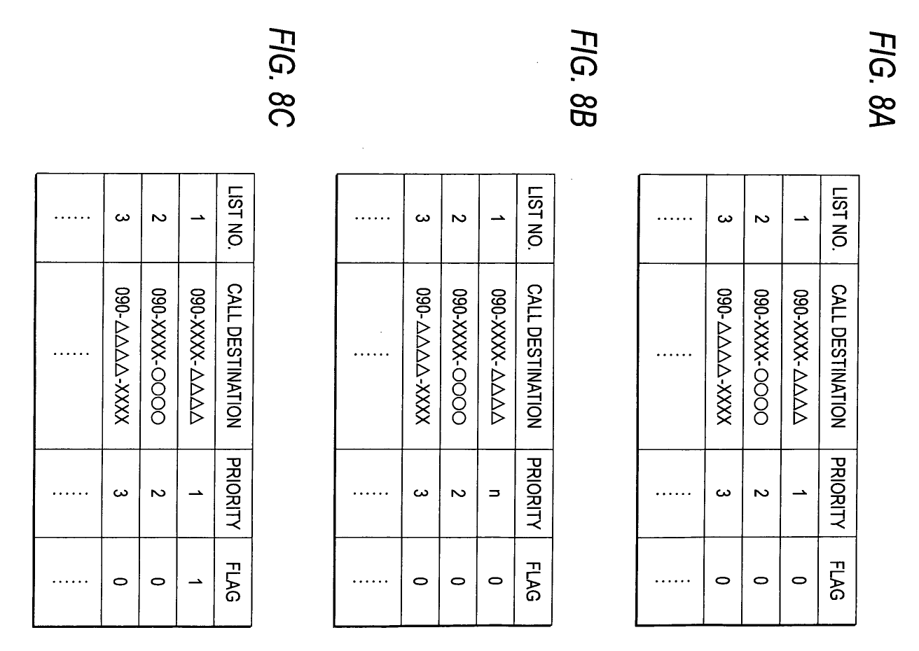

For example, in the case of FIG. 8A, the number “090-xxxx-ΔΔΔΔ” is currently set as a call destination. In case processing of connection to this call destination is not established, the priority of this call destination (“090-xxxx-ΔΔΔΔ”) is updated from “1” to “n” (the lowest priority).

Execution then returns to step S36 and the processing is repeated from step S36.

In case it is determined in step S38 that a connection to the determined call destination is established, the main controller 31 sets, in step S43, for example in the RAM of the main controller 31 a flag to indicate that a connection has been already established (status flag) to ON (sets the flag) for a call destination to which a connection has been established, and temporarily stores, for a call destination t which a connection has been established, the state that a connection has been already established into a register (not shown) in the RAM or elsewhere in association with the call destination list loaded into the RAM of the main controller 31.

For example, in the case of FIG. 8A, when a connection to the number “090-xxxx-ΔΔΔΔ” is established, the flag (indicating that a connection has been established) changes from “0” to “1” as shown in FIG. 8C.

Execution then proceeds to step S44 and the processing is repeated from step S44.

This retries processing of connection to a call destination to which a connection has not been established, until a connection is established thereto. In case a call is originated to a call destination with a high priority, even when the call destination happens to left unconnected, the call origination is repeated so as to reliably connect to a call destination with a high priority, thus notifying a person with a high priority (for example a parent) of the contingency or emergency happening to the user. This enhances the crime prevention effect.

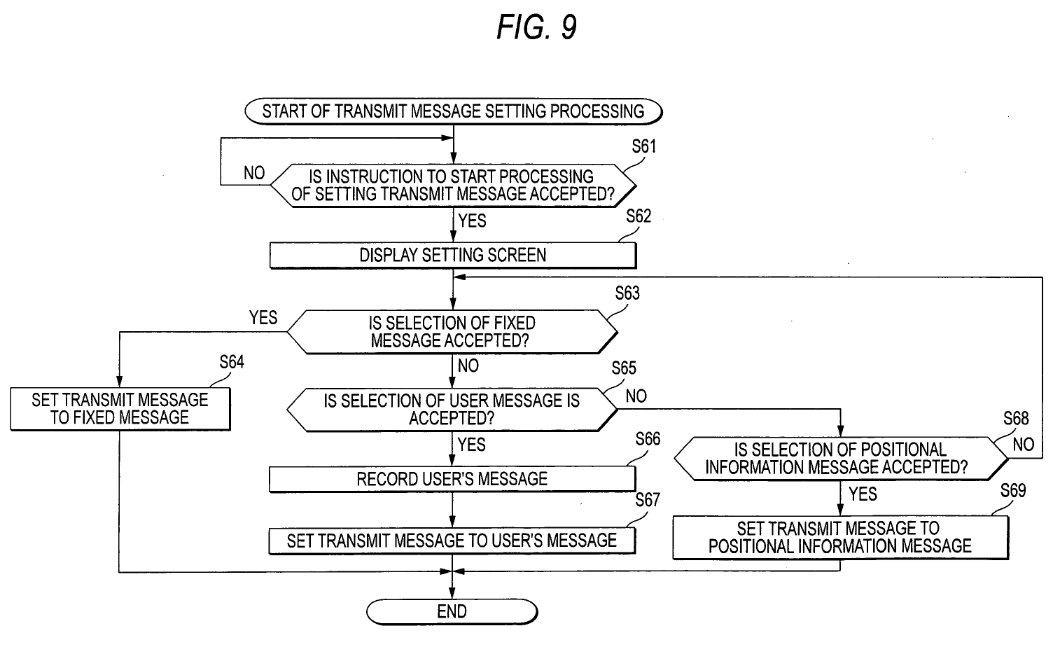

Next, processing of setting a transmit message in the cell phone 1 shown in FIG. 4 will be described referring to the flowchart of FIG. 9. The processing of setting a transmit message is started when an instruction to start processing of setting a transmit message is accepted upon manipulation of the operation key 14 by the user.

In step S61, the main controller 31 determines whether an instruction to start processing of setting a transmit message is accepted upon manipulation of the operation key 14 by the user. The main controller 31 waits until it is determined that an instruction to start processing of setting a transmit message is accepted upon manipulation of the operation key 14 by the user.

In case it is determined in step S61 that an instruction to start processing of setting a transmit message is accepted upon manipulation of the operation key 14 by the user, the main controller 31 controls a LCD controller 36 in step S62 to cause it to present a transmit message setting screen on a liquid crystal display 17. The liquid crystal display 17 displays the transmit message setting screen in accordance with the control of LCD controller 36.

In step S63, the main controller 31 determines whether selection of a fixed message (previously fixed message) is accepted on the transmit message setting screen upon manipulation of the operation key 14 by the user.

In case it is determined in step S63 that selection of a fixed message is accepted on the transmit message setting screen, the main controller 31 sets a transmit message to the fixed message in step S64 and stores the setting data concerning the selected fixed message into the storage 47.

The transmit message setting processing is then terminated.

In case it is determined in step S63 that selection of a fixed message is not accepted on the transmit message setting screen, the main controller 31 determines in step S65 whether selection of a user message (message set in accordance with the preferences of the user) is accepted on the transmit message setting screen upon manipulation of the operation key 14 by the user.

In case it is determined in step S65 that selection of a user message (message set in accordance with the preferences of the user) is accepted on the transmit message setting screen, the main controller 31 uses a microphone 15 to record, in step S66, a message uttered by the user.

To be more precise, the main controller 31 controls the microphone 15 to cause the microphone 15 to collect a message uttered by the user. The microphone 15 collects a message uttered by the user in accordance with the control of the main controller 31.

For example, the microphone 15 collects a message including the user's name.

The main controller 31 controls a voice CODEC 40 to cause it to convert the user's message thus collected to a digital sound signal, compress the signal, and store the compressed digital sound signal into the storage 47.

In step S67, the main controller 31 sets a transmit message to the user's message and stores the setting data concerning the selected user message into the storage 47.

The transmit message setting processing is then terminated.

In case it is determined in step S65 that selection of a user message (message set in accordance with the preferences of the user) is not accepted on the transmit message setting screen, the main controller 31 determines in step S68 whether selection of a positional information message is accepted upon manipulation on the operation key 14 by the user.

In case it is determined in step S68 that selection of a positional information message is not accepted, execution returns to step S63 and the processing is repeated from step S63.

In case it is determined in step S68 that selection of a “positional” information message is accepted, the main controller 31 sets a transmit message to the positional information message and stores the setting data concerning the specified positional information message into the storage 47. By adding positional information (such as positional information that is based on GPS positioning), it is possible to grasp the user's current location more accurately in the search for the user.

The transmit message setting processing is then terminated.

This allows setting of the content of a message to be transmitted to a call destination in accordance with the preferences of the user. It is thus possible to notify a parent of the user of the contingency or emergency the user is facing, and thus enhance the crime prevention effect.

Positional information may be added to a fixed message or a user message.

There have been proposed a technique where the user manipulates a specific operation key or switch to emit a crime prevention notification sound (that is, a crime prevention buzzer) or illuminate an LED (Light Emitting Diode) as well as transmit a mail to a preset predetermined destination or originate a call to a preset predetermined call destination upon contingency or emergency. This technique cannot be the to be effective enough for notification of contingency or emergency.

A mail is repeatedly transmitted or a call is repeatedly placed rather than practiced only once. In case a crime prevention notification sound is silenced or a crime prevention lamp is turned OFF by a criminal or by the user, a mail is repeatedly transmitted or a call is repeatedly placed thereafter. This enhances the crime prevention effect. Crime prevention processing using this method in the cell phone 1 shown in FIG. 4 will be described.

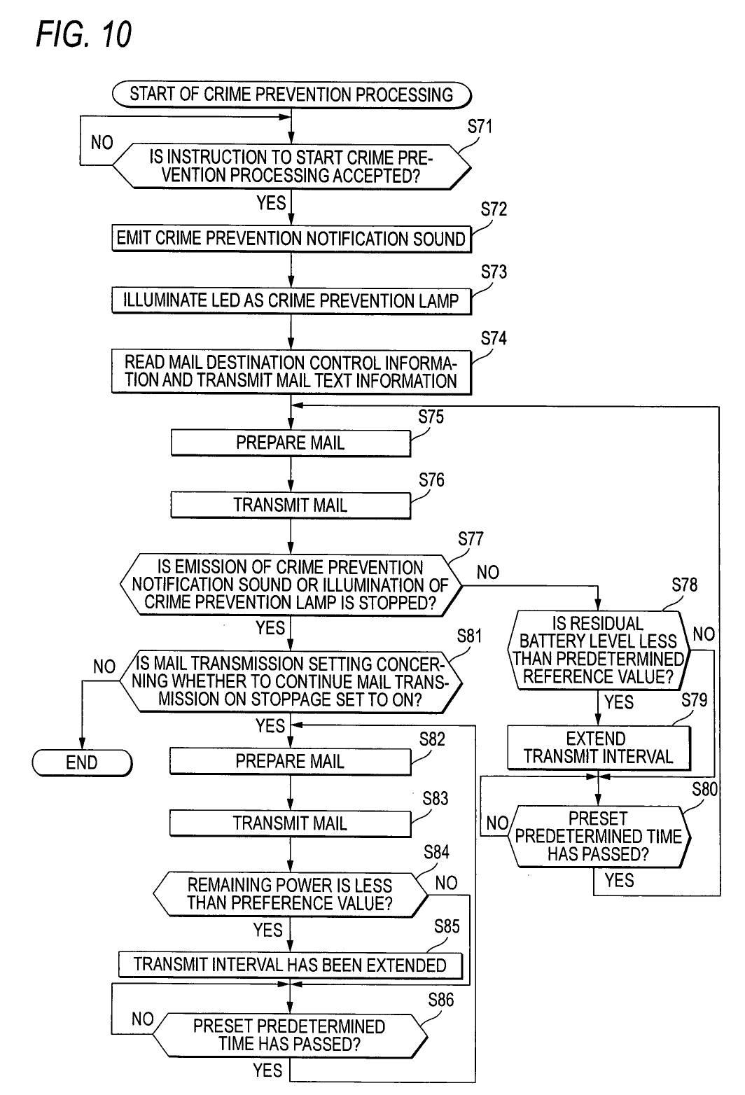

Further crime prevention processing in the cell phone 1 shown in FIG. 4 will be described referring to the flowchart of FIG. 10. This crime prevention processing is started when an instruction to start crime prevention processing is accepted for example upon manipulation of an emergency switch 22 or an operation key 14 by the user.

While the crime prevention processing described referring to the flowchart of FIG. 10 describes only the case where a mail is transmitted upon contingency or emergency in order for simple explanation, the processing is basically the same with the case of placing a call. The corresponding description is redundant and is thus omitted.

In step S71, the main controller 31 determines whether an instruction to start crime prevention processing is accepted for example upon manipulation of the emergency switch 22 or the operation key 14 by the user. The main controller 31 waits until it is determined that an instruction to start crime prevention processing is accepted for example based on the manipulation of the emergency switch 22 or the operation key 14 by the user.

In case it is determined in step S71 that an instruction to start crime prevention processing is accepted for example upon manipulation of the emergency switch 22 or the operation key 14 by the user in step S1, the main controller 31 controls the crime prevention notification sound emission part 50 in step S72 to cause it to emit a crime prevention notification sound for contingency or emergency in accordance with the control of the main controller 31. The crime prevention notification sound emission part 50 emits a crime prevention notification sound for contingency or emergency in accordance with the control of the main controller 31.

In step S73, the main controller 31 controls the LED 23 to cause the LED 23 as a crime prevention lamp for contingency or emergency to illuminate at predetermined intervals. The LED 23 as a crime prevention lamp for contingency or emergency illuminates in accordance with the control of the main controller 31.

The sequence of the processing in step S72 and that in step S73 may be altered or processing in step S72 and that in step S73 may be executed simultaneously in parallel.

In step S74, the main controller 31 reads mail destination control information as control information on the mail destinations stored in the storage 47 and transmit mail text information as text information of a mail to be transmitted.

In step S75, the main controller 31 prepares a mail based on the mail destination control information and transmits mail text information read above. The main controller 31 may activate a GPS receiver 49, receive GPS information from a GPS satellite (not shown), obtain positional information that is based on GPS positioning inculcating the current location of the cell phone 1 by using the received GPS information, and prepare a mail by also using the positional information that is based on GPS positioning obtained above.

In step S76, the main controller 31 transmits a prepared mail to a preset destination via a modulator/demodulator circuit 39, a transmitter/receiver circuit 43, and an antenna 44.

In step S77, the main controller 31 determines whether emission of a crime prevention notification sound by the crime prevention notification sound emission part 50 or illumination of the LED 23 as a crime prevention lamp is stopped by any means or based on an instruction of the user.

In case it is determined in step S77 that the emission of a crime prevention notification sound by the crime prevention notification sound emission part 50 or illumination of the LED 23 as a crime prevention lamp is not stopped by any means or based on an instruction of the user, the main controller 31 determines in step S78 whether the residual level of the power supplied from a power circuit 32 is less than a predetermined reference value (for example 30%).

In case it is determined in step S78 that the residual level of the power supplied from a power circuit 32 is less than a predetermined reference value (for example 30%), the main controller 31 extends in step S79 the transmit interval (time period) for repeating mail transmission by a predetermined time period (for example five minutes).

In case it is determined in step S78 that the residual level of the power supplied from a power circuit 32 is more than a predetermined reference value (for example 30%), the processing in step S79 is skipped and the transmit interval (time period) for repeating mail transmission is not extended.

In step S80, the main controller 31 uses a built-in timer to determine whether a preset transmission interval (for example five minutes) has elapsed and waits until it is determined that preset transmission interval (for example five minutes) has elapsed. In case the transmission interval is extended by the processing in step S79, it is determined whether the extended transmit interval has elapsed.

In case it is determined in step S80 that a preset transmission interval (for example five minutes) has elapsed, execution returns to step S75 and the processing is repeated from step S75. This sequentially transmits a mail at preset predetermined transmission intervals.

In case it is determined that the emission of a crime prevention notification sound by the crime prevention notification sound emission part 50 or illumination of the LED 23 as a crime prevention lamp is stopped by any means or based on an instruction of the user, the main controller 31 determines in step S81 whether the mail transmission setting concerning whether to continue mail transmission on stoppage of the emission of a crime prevention notification sound or illumination of the LED 23 as a crime prevention lamp is set to ON.

The mail transmission setting is previously set in accordance with the preferences of the user.

In case it is determined in step S81 that the mail transmission setting concerning whether to continue mail transmission on stoppage of the emission of a crime prevention notification sound or illumination of the LED 23 as a crime prevention lamp is not set to ON (that is, the mail transmission setting concerning whether to continue mail transmission on stoppage of the emission of a crime prevention notification sound or illumination of the LED 23 as a crime prevention lamp is set to OFF), the crime prevention processing is terminated. In case the mail transmission setting concerning whether to continue mail transmission on stoppage of the emission of a crime prevention notification sound or illumination of the LED 23 as a crime prevention lamp is set to OFF, no mails are transmitted once the emission of a crime prevention notification sound or illumination of the LED 23 as a crime prevention lamp is stopped.

In case it is determined in step S81 that the mail transmission setting concerning whether to continue mail transmission on stoppage of the emission of a crime prevention notification sound or illumination of the LED 23 as a crime prevention lamp is set to ON, the main controller 31 determines in step S82 whether the residual level of the power supplied from the power circuit 32 is less than a predetermined reference value (for example 30%).

In case it is determined in step 82 that the residual level of the power supplied from a power circuit 32 is less than a predetermined reference value (for example 30%), the main controller 31 extends in step S83 the transmit interval (time period) for repeating mail transmission by a predetermined time period (for example five minutes).

In case it is determined in step S82 that the residual level of the power supplied from a power circuit 32 is more than a predetermined reference value (for example 30%), the processing in step S83 is skipped and the transmit interval (time period) for repeating mail transmission is not extended.

In step S84, the main controller 31 uses a built-in timer to determine whether a preset transmission interval (for example five minutes) has elapsed and waits until it is determined that preset transmission interval (for example three minutes) has elapsed. In case the transmission interval is extended by the processing in step S83, it is determined whether the extended transmit interval has elapsed.

In case it is determined in step S84 that a preset transmission interval (for example five minutes) has elapsed, execution returns to step S82 and the processing is repeated from step S82. This sequentially transmits a mail every preset predetermined transmission interval even after the emission of a crime prevention notification sound or illumination of the LED 23 as a crime prevention lamp is stopped.

The repetitive mail transmission processing is terminated for example with the user's manipulation of the operation key 14. The procedure to terminate the notification feature (mail transmission or call origination) may include acceptance of input of a personal identification number.

With the crime prevention processing described referring to the flowchart of FIG. 10, it is possible to sound a crime prevention notification tone (that is, a crime prevention buzzer) or illuminate the LED 23 as well as transmit a mail to a preset predetermined destination every preset transmission interval (for example five minutes) or originate a call to a preset predetermined call destination every preset call origination interval (for example 10 minutes).

In case the mail transmission setting concerning whether to continue mail transmission on stoppage of the emission of a crime prevention notification sound or illumination of the LED 23 as a crime prevention lamp is set to ON, it is possible to transmit a mail to a preset predetermined destination every preset transmission interval (for example five minutes) or originate a call to a preset predetermined call destination every preset call origination interval (for example 10 minutes) even after the emission of a crime prevention notification sound or illumination of the LED 23 as a crime prevention lamp is stopped, same as before that.

In case the mail transmission setting concerning whether to continue mail transmission on stoppage of the emission of a crime prevention notification sound or illumination of the LED 23 as a crime prevention lamp is set to OFF, mail transmission or call origination does not take place once the emission of a crime prevention notification sound or illumination of the LED 23 as a crime prevention lamp is stopped.

In case the residual battery level of the cell phone 1 has dropped below a predetermined reference value during mail transmission or call origination, it is possible to extend a transmission interval or a call origination interval.

This repeatedly transmits a mail or originates a call at preset transmission intervals or call origination intervals in the presence of contingency or emergency with simple manipulation by the user (without repeated manipulations). This enhances the convenience and operability in the crime prevention processing in the cell phone 1.

This enhances the crime prevention effect.

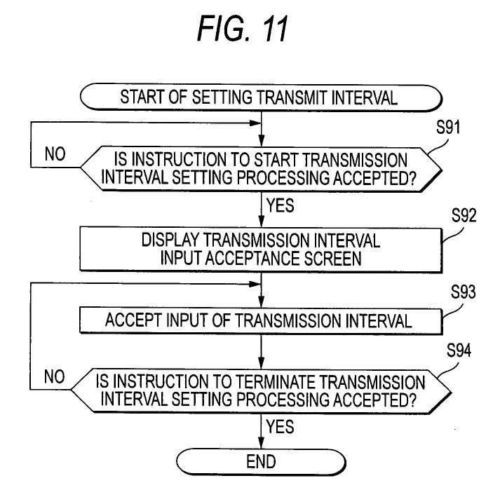

Next, the transmission interval setting processing in the cell phone 1, as shown in FIG. 4, will be described referring to the flowchart of FIG. 11. The transmission interval setting processing is started when an instruction to start transmission interval setting processing is accepted for example upon manipulation of an operation key 14 by the user.

In step S91, the main controller 31 determines whether an instruction to start transmission interval setting processing is accepted upon manipulation of the operation key 14 by the user. The main controller 31 waits until it is determined that an instruction to start transmission interval setting processing is accepted upon manipulation of the operation key 14 by the user.

In case it is determined in step S91 that an instruction to start transmission interval setting processing is accepted, the main controller 31 controls, in step S92, the LCD controller 36 to cause it to present a transmit interval input acceptance screen on a liquid crystal display 17. The liquid crystal display 17 displays the transmit interval input acceptance screen in accordance with the control of LCD controller 36.

In step S93, the main controller 31 accepts input of a transmission interval upon manipulation of the operation key 14 by the user.

For example, input of “five minutes” is accepted as a transmission interval.

In step S94, the main controller 31 determines whether an instruction to terminate transmission interval setting processing is accepted upon manipulation of the operation key 14 by the user.

In case it is determined in step S94 that an instruction to terminate transmission interval setting processing is not accepted upon manipulation of the operation key 14 by the user, execution returns to step S93 and the processing is repeated from step S93.

In case an instruction to terminate transmission interval setting processing is accepted upon manipulation of the operation key 14 by the user, the transmission interval setting processing is terminated.

This sets the transmission interval of a mail to be repeatedly transmitted in the presence of contingency or emergency in accordance with the preferences of the user.

While the transmit interval of a mail to be repeatedly transmitted in the presence of contingency or emergency is set in the transmission interval setting processing described using the flowchart of FIG. 11, the call origination interval (for example 10 minutes) of a call may be set also.

A preferable interval may be set as a transmission interval or a call origination interval.

As well as in the presence of contingency or emergency, a mail may be transmitted to a preset predetermined destination or a call may be originated to a preset call destination so that a child will not be involved in contingency or emergency on his/her way back home from a cram school or the like at nighttime. This enhances the crime prevention effect before contingency or emergency take place. Crime prevention processing using this method will be described.

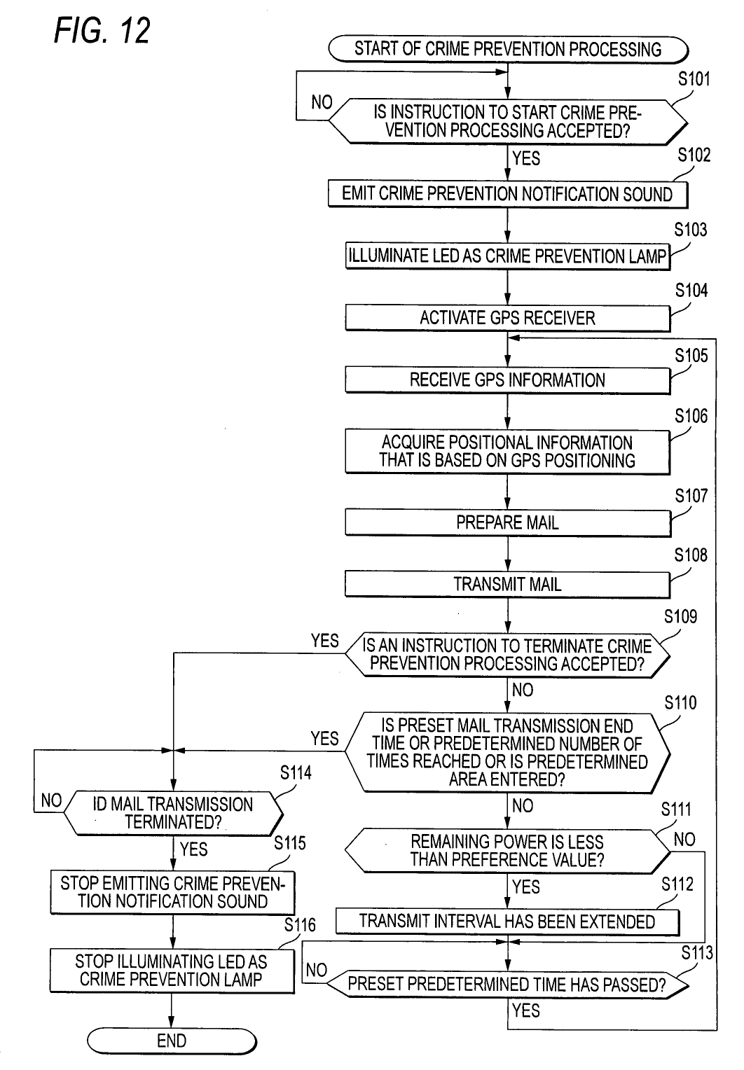

Crime prevention processing in the cell phone 1 shown in FIG. 4 will be described referring to the flowchart of FIG. 12. This crime prevention processing is started when an instruction to start crime prevention processing is accepted for example upon manipulation of an emergency switch 22 or an operation key 14 by the user.

While the crime prevention processing described referring to the flowchart of FIG. 12 describes only the case where a mail is transmitted upon contingency or emergency in order for simple explanation, the processing is basically the same with the case of placing a call. The corresponding description is redundant and is thus omitted.

In step S101, the main controller 31 determines whether an instruction to start crime prevention processing is accepted for example upon manipulation of the emergency switch 22 or the operation key 14 by the user. The main controller 31 waits until it is determined that an instruction to start crime prevention processing is accepted for example based on the manipulation of the emergency switch 22 or the operation key 14 by the user.

In case it is determined in step S101 that an instruction to start crime prevention processing is accepted for example upon manipulation of the emergency switch 22 or the operation key 14 by the user, the main controller 31 controls the crime prevention notification sound emission part 50 in step S102 to cause it to emit a crime prevention notification sound for contingency or emergency. The crime prevention notification sound emission part 50 emits a crime prevention notification sound for contingency or emergency in accordance with the control of the main controller 31.

In step S103, the main controller 31 controls the LED 23 to cause the LED 23 as a crime prevention lamp for contingency or emergency to illuminate at predetermined intervals. The LED 23 as a crime prevention lamp for contingency or emergency illuminates in accordance with the control of the main controller 31.

The sequence of the processing in step S102 and that in step S103 may be altered or processing in step S102 and that in step S103 may be executed simultaneously in parallel.

In step S104, the main controller 31 makes control to activate a GPS receiver 49. The GPS receiver 49 is activated in accordance with the control of the main controller 31. In step S105, the GPS receiver 49 receives positional information indicating the current location of the cell phone 1 from a GPS satellite (not shown). The GPS information includes for example origination time information from respective GPS satellites.

The GPS receiver 49 supplies the GPS information received from the GPS satellite (not shown) to the main controller 31 via a main bus 41.

In step S106, the main controller 31 acquires GPS information supplied from the GPS receiver 49. Then, the main controller 31 uses the acquired GPS information to calculate positional information (latitude and longitude information) indicating the current location of the cell phone 1 (preferably from three or four pieces of GPS information) and obtain the positional information indicating the current location of the cell phone 1. In step S107, the main controller 31 reads the mail preparation control information stored in the storage 47 for preparing a mail (including text data for preparing a mail) and prepares a mail based on the readout mail preparation control information and the acquired positional information (positional information indicating the current location of the cell phone 1 that is based on GPS positioning).

In step S108, the main controller 31 transmits the prepared mail (positioning mail) to another cell phone 1 or a persona computer (not shown) as a preset destination via a modulator/demodulator circuit 39, a transmitter/receiver circuit 43, and an antenna 44.

In step S109, the main controller 31 determines whether an instruction to terminate the crime prevention processing is accepted upon manipulation of the operation key 14 by the user.

In case it is determined in step S109 that an instruction to terminate the crime prevention processing is not accepted, the main controller 31 determines in step S110 whether a preset mail transmission end time or a predetermined number of times is reached or a predetermined area is entered.

That is, whether the preset mail transmission end time is already reached, whether a mail has been transmitted for a preset predetermined number of times (for example, three times), or whether the cell phone 1 has entered a preset area.

To be more specific, for the mail transmission end time in case the cram school the child attends is scheduled to end at 21:00 and it takes 30 minutes to go back home, the mail transmission end time is set to 21:45 for example. For the number of times, in case the mail transmission interval is set to 15 minutes and the cram school the child attends is scheduled to end at 21:00, setting is made to transmit a mail three times every 15 minutes starting at 21:00. Whether the cell phone 1 has entered a predetermined area is determined using the positional information obtained using GPS information that is based on GPS positioning.

In case it is determined in step S110 that a preset mail transmission end time or a predetermined number of times is not reached or a predetermined area is not entered, the main controller 31 determines in step S111 whether the residual level of the power supplied from the power circuit 32 is less than a predetermined reference value (for example 30%).

In case it is determined in step 111 that the residual level of the power supplied from a power circuit 32 is less than a predetermined reference value (for example 30%), the main controller 31 extends in step S112 the transmit interval (time period) for repeating mail transmission by a predetermined time period (for example five minutes).

In case it is determined in step S111 that the residual level of the power supplied from a power circuit 32 is more than a predetermined reference value (for example 30%), the processing in step S112 is skipped and the transmit interval (time period) for repeating mail transmission is not extended.

In step S113, the main controller 31 uses a built-in timer to determine whether a preset transmission interval (for example five minutes) has elapsed and waits until it is determined that preset transmission interval (for example three minutes) has elapsed. In case the transmission interval is extended by the processing in step S112, it is determined whether the extended transmit interval has elapsed.

In case it is determined in step S113 that a preset transmission interval (for example five minutes) has elapsed, execution returns to step S105 and the processing is repeated from step S105. This sequentially transmits a mail every preset transmission interval.

In case it is determined in step S110 that a preset mail transmission end time or a predetermined number of times is reached or a predetermined area is entered, execution proceeds to step S114.

Also in case it is determined in step S109 that an instruction to terminate crime prevention processing is accepted, execution proceeds to step S114.

In step S114, the main controller 31 determines whether a mail has been transmitted via the modulator/demodulator circuit 39, the transmitter/receiver circuit 43, and the antenna 44 and waits until it is determined that a mail has been transmitted. In case it is determined in step S114 that a mail has been transmitted, the main controller 31 stops emission of the crime prevention notification sound by the crime prevention notification sound emission part 50 in step S115 and stops illumination of the LED 23 in step S116. The crime prevention processing is then terminated.

In the crime prevention processing described referring to the flowchart of FIG. 12, it is possible to determine whether a predetermined condition has been satisfied including a preset mail transmission end time, a number of times or an area when a mail is transmitted or a call is originated as notification upon contingency or emergency or upon non-contingency or non-emergency. It is also possible to repeat mail transmission or call origination until a predetermined condition has been satisfied including a preset mail transmission end time, a number of times or an area. It is possible to add positional information (such as positional information that is based on GPS positioning) when transmitting a mail or originating a call. This repeats notification including positional information with simple operation thus readily enhancing the crime prevention effect.

In case there is little difference in the positional information (positional information that is based on GPS positioning) obtained using the GPS information received by the GPS receiver 49, the mail preparation process may be skipped. Or, a method for saving the history of positional information that is based on GPS positioning may be simplified or stored in compressed form while a mail is prepared and transmitted. Further, repetitive mail transmission or call origination processing is terminated for example upon manipulation of the operation key 14 by the user. Input acceptance of a personal identification number may be made in the operation to terminate the notification feature (mail transmission or call origination). This prevents a criminal from intentionally aborting mail transmission thus enhancing the crime prevention effect.

While the crime prevention processing described referring to the flowchart of FIG. 12 is started based on an instruction to start crime prevention processing triggered by manipulation of an emergency switch 24, the embodiment is not limited thereto but the crime prevention processing may be triggered when a preset predetermined start time (for example 21:00) is reached or when the cell phone 1 has entered a predetermined location (such as the neighborhood of a predetermined station) Or, the crime prevention processing may be started when it is detected that the surroundings are dark by using the light quantity detected with an optical sensor (not shown), or when large sound is collected with a microphone 15. Such conditions are defined as “notification start conditions”.

While in the crime prevention, processing described referring to the flowchart of FIG. 12 crime prevention notification sound is emitted at the same time as illumination of an LED, the embodiment is not limited thereto but emission of crime prevention notification sound and illumination of an LED may not occur at the same time. This prematurely enhances the crime prevention effect also in a case (non-contingency or non-emergency) where emission of crime prevention notification sound and illumination of an LED need not take place at the same time.

Setting of a predetermined condition such as a mail transmission end time, a number of times or an area is started when an instruction to start condition setting processing is made by manipulation of the operation key 14 by the user. For example, input or selection of a mail transmission end time, a number of times of transmission or a transmission interval is accepted. The above condition is set based on the input or selection of the accepted mail transmission end time, number of times of transmission or transmission interval.

The embodiment is applicable to the cell phone 1 as well as a PDA (Personal Digital Assistant), a personal computer, a handheld game machine, a handheld music player, a handheld video player and other types of information processing apparatus.

A series of processing described in the above embodiment may be executed by software as well as by hardware.

While the steps in each flowchart are chronologically executed in the order they are described in the above embodiment, the steps need not always be executed chronologically but may include those executed in parallel or individually executed.

The above-described embodiments enhance the crime prevention effect.

What is claimed is:

1. An information processing apparatus comprising:
an emission unit configured to emit a notification sound upon predetermined operation;
a storage unit configured to store a call destination list including a plurality of call destinations;
a determination unit configured to determine a call destination based on a preset priority from the plurality of call destinations if the predetermined operation is performed; and
a call origination unit configured to originate a call to the determined call destination.

2. The information processing apparatus according to claim 1, wherein, if a connection to the call destination by the call origination unit is not established after the call is originated to the call destination, the determination unit determines a new call destination based on a preset priority from the plurality of call destinations of the call destination list.

3. The information processing apparatus according to claim 1, wherein the call origination unit originates a preset message to the call destination connected by the connection unit.

4. The information processing apparatus according to claim 1, wherein the preset message is a voice message which is previously recorded.

5. The information processing apparatus according to claim 1, wherein the preset message is a descriptive message which is previously recorded.

6. An information processing apparatus comprising:
an emission unit configured to emit a notification sound upon predetermined operation;
a preparation unit configured to prepare a mail text information of a transmit mail which is previously stored;
a transmission unit configured to transmit the mail to a preset destination;
a determination unit configured to determine whether the emission unit stops to emit the notification sound; and
a control unit configured to cause the transmission unit to control to repeat, every preset predetermined transmit interval, a transmission of the mail if it is determined by the determination unit that the emission unit stops to emit the notification sound.

7. The information processing apparatus according to claim 6, wherein, if it is determined that a residual level of a power of the information processing apparatus is less than a predetermined reference value, the predetermined transmit interval is extended.

8. An information processing apparatus comprising:
an emission unit configured to emit a notification sound upon predetermined operation;
an acquisition unit configured to acquire information concerning a position of the information processing apparatus;
a preparation unit configured to preparing a mail based on the information;
a transmission unit configured to transmit the mail;
a determination unit configured to determine whether an condition to end a transmission of the mail is satisfied; and
a control unit configured to cause the transmission unit to control to repeat, every preset predetermined transmit interval, the transmission of the mail if it is determined by the determination unit that the condition is not satisfied.

9. The information processing apparatus according to claim 8, wherein, if it is determined that a residual level of a power of the information processing apparatus is less than a predetermined reference value, the predetermined transmit interval is extended.

10. An information processing apparatus comprising:
an emission unit configured to emit a notification sound;
an acquisition unit configured to acquire information concerning a position of the information processing apparatus;
a call origination unit configured to originate a call to another information processing apparatus based on the information acquired by the acquisition unit;
a determination unit configured to determine whether a condition to end the call is satisfied; and
a control unit configured to cause the call origination unit to control to repeat, every preset predetermined originating interval, the call if it is determined by the determination unit that the condition is not satisfied.

11. The information processing apparatus according to claim 10, wherein, if it is determined that a residual level of a power of the information processing apparatus is less than a predetermined reference value, the predetermined originating interval is extended.

12. An information processing method comprising:
emitting a notification sound upon predetermined operation;
determining a call destination based on a preset priority from a plurality of call destinations included in a call destination list if the predetermined operation is performed; and
originating a call to the determined call destination.

13. The information processing method according to claim 12, comprising:
determining a new call destination based on the preset priority from the plurality of call destinations of the call destination list if a connection to the call destination is not established after the call is originated to the call destination.

14. The information processing method apparatus according to claim 12, comprising:
originating a preset message to the call destination connected by the connection unit.

15. The information processing method according to claim 14, wherein the preset message is a voice message which is previously recorded.

16. The information processing method according to claim 14, wherein the preset message is a descriptive message which is previously recorded.
